(19) United States
(12) Patent Application Publication
(10) Pub. No.: US 2018/0136348 A1
(43) Pub. Date: May 17, 2018

(54) Seismic Sensor Cable

(71) Applicant: WESTERNGECO LLC, Houston, TX (US)

(72) Inventors: Fabien Guizelin, Oslo (NO); Susanne Rentsch-Smith, Hove (GB); Bent Andreas Kjellesvig, Oslo (NO)

(21) Appl. No.: 15/572,780

(22) PCT Filed: Jun. 8, 2016
(86) PCT No.: PCT/US2016/036299

§ 371 Date: Nov. 8, 2017

Related U.S. Application Data
(60) Provisional application No. 62/172,246, filed on Jun. 8, 2015.
(60) Provisional application No. 62/173,368, filed on Jun. 10, 2015.

(51) Int. Cl. G01V 1/20

(52) U.S. Cl. CPC G01V 1/201; G01P 15/0802; G01V 2001/207

(57) ABSTRACT

A seismic streamer in accordance to aspects of the disclosure includes an outer skin formed in a longitudinally extending tubular shape, an inner surface of the outer skin defining an internal volume, a strength member that extends through the internal volume in a direction parallel to that of the longitudinally extending tubular shape, a filler material disposed in the internal volume and a sensor housing located in the internal volume and internally disposing a seismic sensor.

### CROSS-REFERENCES TO RELATED APPLICATIONS

This application claims the benefit under 35 U.S.C. § 119(e) of U.S. Provisional Patent Application No. 62/172,246, filed 8 Jun. 2015, and No. 62/173,368, filed 10 Jun. 2015, which are incorporated herein by reference in its entirety as if fully set forth herein.

### BACKGROUND

This section provides background information to facilitate a better understanding of the various aspects of the disclosure. It should be understood that the statements in this section of this document are to be read in this light, and not as admissions of prior art.

Seismic surveys are used to determine various features of an earth formation, such as the presence or lack thereof of various minerals. Seismic surveys can be used to determine if hydrocarbon deposits are present in an earth formation. A seismic survey can be performed by using a seismic source to produce an impulse that travels into an earth formation thereby reverberating and/or reflecting off of the earth formation. The reverberations and/or reflections are then detected and recorded by a seismic sensor and recording system. The data that is derived therefrom can be analyzed and used to determine characteristics of the formation. It is possible to display such in a visual form, or keep it in digital data form.

One type of seismic survey takes place on land and is called a land seismic survey. In land seismic surveys an impulse is introduced into the formation and seismic sensors are placed in contact with the formation (on and/or into the formation). The sensors can be hydrophones, geophones, or other general types of sensors capable of detecting the reverberations and/or reflections of the impulse. It is possible to use a large spread of interconnected sensors that in turn connect with a recording device(s). Some of the issues encountered in a land survey are lighting strikes, animal damage (e.g., rats chewing cables), and other degradations caused by the elements. The sensors in a spread can be connected by way of wireless communication, cabled communication, or a combination thereof. Sensors can also be in what is called a “blind” configuration, where a sensor or group of sensors are connected to a recording device that is independent of a central recording unit, and is scavenged at various times in various ways.

Another type of survey is a marine seismic survey, and within that a towed marine seismic survey. In a towed marine seismic survey a boat tows a series of seismic streamers. Seismic streamers are cables that have integrated thereto and/or therein seismic sensors. In the same spirit as a land survey, a marine seismic survey introduces an impulse to the earth formation. The impulse can be created by air guns or marine vibrators. The impulse(s) can travel through the water and into the formation, where they reverberate and/or reflect. The reverberations and/or reflections travel back through the water and are detected by the seismic sensors on the streamers and can be recorded. The data that is derived therefrom can be analyzed and used to determine characteristics of the formation. It is possible to display such in a visual form, or keep it in data form. It is also possible to use seismic sensors that are located on the seabed.

Though potentially relevant in all seismic surveys, there is value in obtaining multi-component seismic data as such can facilitate numerous data processing aspects such as deghosting, noise removal, and other attenuation and processing techniques. That being said, the cost of the equipment is relevant with respect to its commercial usefulness. Multi-component data can be considered to be directional particle motion data for multiple directions, pressure data, rotational data, or a combination thereof.

### SUMMARY

In accordance to aspects of the disclosure a seismic sensor unit for use in a seismic streamer includes an accelerometer and sensor electronics disposed inside of an elongated enclosed housing. An example of a method includes disposing in an internal volume of an outer skin of a seismic streamer a longitudinally extending sensor housing that internally carries a seismic sensor.

A seismic streamer in accordance to aspects of the disclosure includes an outer skin formed in a longitudinally extending tubular shape, an inner surface of the outer skin defining an internal volume, a strength member that extends through the internal volume in a direction parallel to that of the longitudinally extending tubular shape, a filler material disposed in the internal volume and a sensor housing located in the internal volume and internally disposing a seismic sensor.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 is a schematic diagram of a marine seismic survey system incorporating multi-component seismic cables and features in accordance to aspects of the disclosure.

FIG. 2 illustrates a portion of seismic streamer disposing a decoupled floating seismic sensor unit according to one or more aspects of the disclosure.

FIG. 3 illustrates a non-limiting example of a seismic sensor unit disposed with a sensor spacer device according to one or more aspects of the disclosure.

FIG. 4 an end view along a longitudinal axis of seismic sensor unit disposed with and coupled to a sensor spacer device according to one or more aspects of the disclosure.

FIG. 5 is an end view along a longitudinal axis of seismic cable having an internal seismic sensor unit disposed with and coupled to a sensor spacer device and the cable strength members according to one or more aspects of the disclosure.

FIG. 6 is an end view along a longitudinal axis of seismic cable having an internal seismic sensor unit disposed with and decoupled from a sensor spacer device and the cable strength members according to one or more aspects of the disclosure.

FIG. 7 illustrates a portion of a seismic streamer incorporating a seismic sensor unit that is disposed with a sensor spacer device according to one or more aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

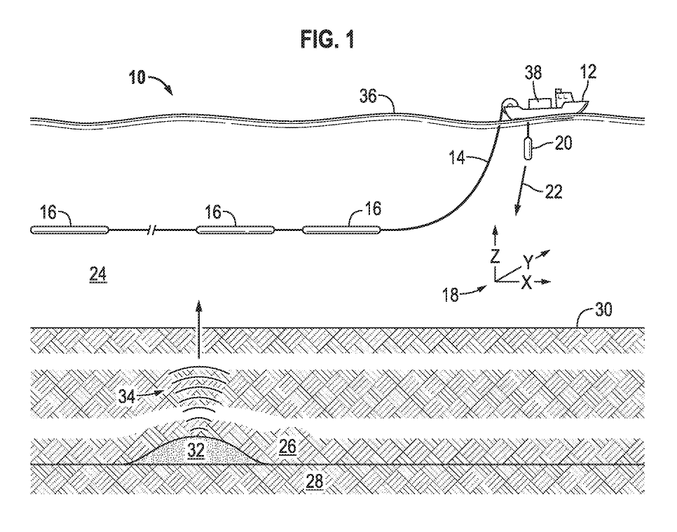

FIG. 1 depicts a marine seismic survey system 10 in accordance with embodiments of the disclosure. In the illustrated seismic survey system 10 a survey vessel 12 tows one or more multi-component seismic cables 14 (i.e., seismic streamer) behind the vessel 12. The seismic streamers 14 may be several thousand meters long and may contain various support cables as well as wiring and/or circuitry that may be used to support power and communication along the streamers 14. In general, each streamer 14 includes a primary cable into which is mounted seismic sensor units 16 that record seismic signals. Seismic sensors can include hydrophones, geophones, accelerometers, microelectromechanical system (MEMS) sensors, or any other types of sensors that measure the translational motion (e.g. displacement, velocity, and/or acceleration) of the surface at least in the vertical direction and possibly in one or both horizontal directions. Such sensors are referred to as translational survey sensors, since they measure translational (or vectorial) motion. Each seismic sensor can be a single-component (1C), two-component (2C), or three-component (3C) sensor. A 1C sensor has a sensing element to sense a wavefield along a single direction; a 2C sensor has two sensing elements to sense wavefields along two directions (which can be generally orthogonal to each other, to within design, manufacturing, and/or placement tolerances); and a 3C sensor has three sensing elements to sense wavefields along three directions (which can be generally orthogonal to each other). For the case of multi-component seismic sensors, the sensors are capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components (see axes 18, for example)) of a particle velocity and one or more components of a particle acceleration.

Depending on the particular embodiment of the disclosure, the seismic sensors may include hydrophones, geophones, particle displacement sensors, particle velocity sensors, accelerometers, pressure gradient sensors, or combinations thereof. For example, in accordance with some embodiments of the disclosure, a particular multi-component seismic sensor arrangement may include a hydrophone for measuring pressure and three orthogonally-aligned accelerometers to measure three corresponding orthogonal components of particle velocity and/or acceleration near the seismic sensor. It is noted that a multi-component seismic sensor assembly may be implemented as a plurality of devices that may be substantially co-located. A particular seismic sensor may include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, at a particular point, seismic data indicative of the pressure data with respect to the inline direction.

The marine seismic survey (i.e., data acquisition) system 10 includes a seismic source 20 that may be formed from one or more seismic source elements, such as air guns, for example, which are connected to the survey vessel 12. Alternatively, in other embodiments of the disclosure, the seismic source 20 may operate independently of the survey vessel 12, in that the seismic source may be coupled to other vessels or buoys, as just a few examples.

As the seismic streamers 14 are towed behind the survey vessel 12, acoustic signals 22 often referred to as “shots,” are produced by the seismic source 20 and are directed down through a water column 24 into strata 26 and 28 beneath a water bottom surface 30. The acoustic signals 22 are reflected from the various subterranean geological formations, such as formation 32 depicted in FIG. 1.

The incident acoustic signals 22 produce corresponding reflected acoustic signals, or pressure waves 34, which are sensed by the seismic sensor units 16. It is noted that the pressure waves that are received and sensed by the seismic sensor units 16 include “up going” pressure waves that propagate to the sensor units 16 without reflection, as well as “down going” pressure waves that are produced by reflections of the pressure waves 34 from an air-water boundary 36.

The seismic sensor units 16 generate signals (digital signals, for example), called “traces,” which indicate the acquired measurements of the pressure wavefield and particle motion (if the sensors are particle motion sensors). The traces are recorded and may be at least partially processed by a signal processing unit 38 that is deployed on the survey vessel 12, in accordance with some embodiments of the disclosure.

The goal of the seismic acquisition is to build up an image of a survey area for purposes of identifying subterranean geological formations 32. Subsequent analysis of the representation may reveal probable locations of hydrocarbon deposits in subterranean geological formations. Depending on the particular embodiment of the disclosure, portions of the analysis of the representation may be performed on the seismic survey vessel 12, such as by the signal processing unit 38.

A configuration of a marine seismic cable can include a long tubular shaped body. The body can include an outer skin that encloses one or more stress members, seismic sensors, spacers to support the skin, a filler material and electrical wiring that transmits power and information between various components (e.g., processors and sensors). In general, the filler material typically has a density to make the overall streamer neutrally buoyant.

In marine seismic cables the inner workings of the cable are supported in various ways. It should be appreciated that the support structures inside the streamer contribute to the measurement ability of the sensors since the sensors are very sensitive and noise is a significant consideration and issue. A structure may adequately support the sensors and associated wiring, yet introduce an unacceptable amount of noise to the readings. Conversely, a support structure may be acceptable with regard to noise and other signal detection aspects, but not adequately provide structural support. Further, a sensor may be properly supported and provide adequate noise attributes, but the cost of the hardware may be too expensive to be commercially viable. Fine points of the support structure of a seismic streamer can provide magnified affect with respect to the performance of the sensors in the streamer as well as the cost of the product.

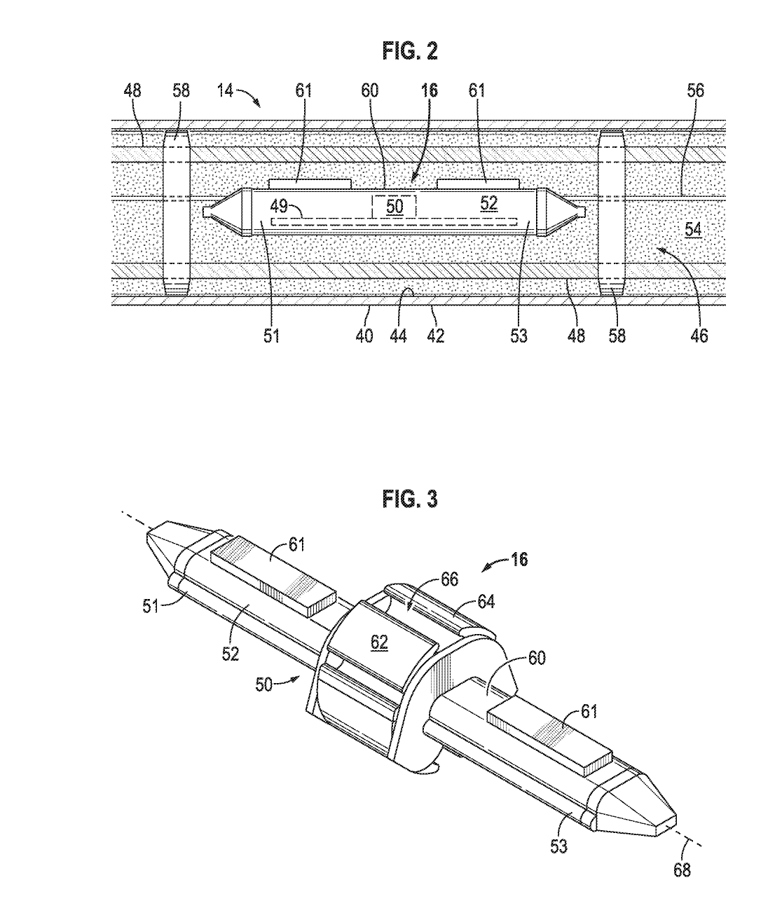

FIG. 2 illustrates a portion of a seismic streamer cable 14 that carries a sensor unit 16 according to aspects of the disclosure that is decoupled and “floating” in the streamer. The streamer 14 includes an outer skin 40 that defines an outer surface 42 and an inner surface 44, the outer skin being formed in a longitudinally extending tubular shape. The inner surface 44 of the outer skin 40 defines an internal volume 46. At least one strength member 48 (e.g., KEVLAR, a registered trademark of DuPont) extends longitudinally through the internal volume 46 for example in a direction parallel to that of the longitudinally extending tubular shape. In FIG. 2 a pair of spaced apart strength members 48 extend longitudinally within the internal volume 46. For example, the strength members 48 may be spaced apart and located about 180 degrees from one another. A sensor unit 16 in accordance to aspects of the disclosure is disposed in the internal volume 46. The internal volume 46 is filled with a filler material 54 to support the sensor unit and the outer skin and other components such as electrical wires 56. The filler material 54 may be a gas, liquid, gel, or foam that may provide sensing performance attributes as well as support the inner hardware within the outer skin. The filler material (e.g., gel or foam) may serve to reduce coupling (decouple) the accelerometers from the streamer skin and/or the strength members. In the depicted example, spacers 58 are also disposed in the internal volume to support the outer skin. Non-limiting examples of spacers 58 are described for example in US Patent publication Nos. 2009/0323468 and 2011/0273957, the teachings of which are incorporated by reference.

The depicted sensor unit 16 includes a sensor 50, e.g. accelerometer, and sensor electronics 49 disposed in and carried by a longitudinal extending sensor housing 52. A seismic sensor 50 may include at least one microelectromechanical system (MEMS) based sensor accelerometer, which may be advantageous due to its size, low power dissipation and low cost. The sensor housing 52 includes a first end 51 and a second end 53 longitudinally separated from one another.

In accordance to an embodiment the sensor housing 52 is greater than about 100 mm in length. In accordance to an embodiment the sensor housing is greater than about 150 mm. In accordance to an embodiment the sensor housing extends in the longitudinal direction about 200 mm or longer. The sensor can be a gradient sensor when configured in this manner. The accelerometer may be a two axis or a three axis accelerometer. The longitudinal sensor housing may be constructed for example of a metal or a polymer. The cross-section of the sensor housing 52 may be circular or non-circular. The longitudinal sensor housing 52 may have an outer planar surface 60 for example on which floatation or buoyancy elements 61 may be attached. For example, in FIG. 2 the sensor unit 16 with the buoyancy elements 61 may be substantially neutrally buoyant in the filler material 54. By making the sensor unit 16 neutrally buoyant relative to the filler material (e.g., the sensor unit and filler having the same density), the sensor 50 is coupled with the filler 54. This may be desired for example when the sensor is decoupled from the mechanical strength member. In some embodiments the sensor unit 16 may not include the buoyancy elements 61. It should be recognized that the sensor 50, i.e., sensor unit 16, mounting configuration may be selected in combination with the selection of the filler 54 material, the outer skin 40 material, and the material of strength member 48 as these components affect the noise characteristics.

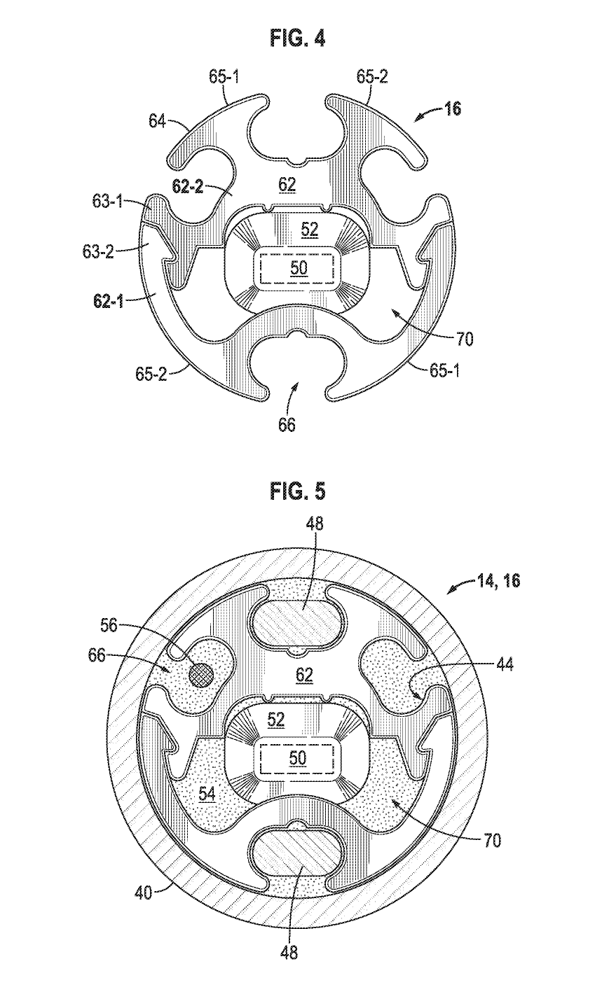

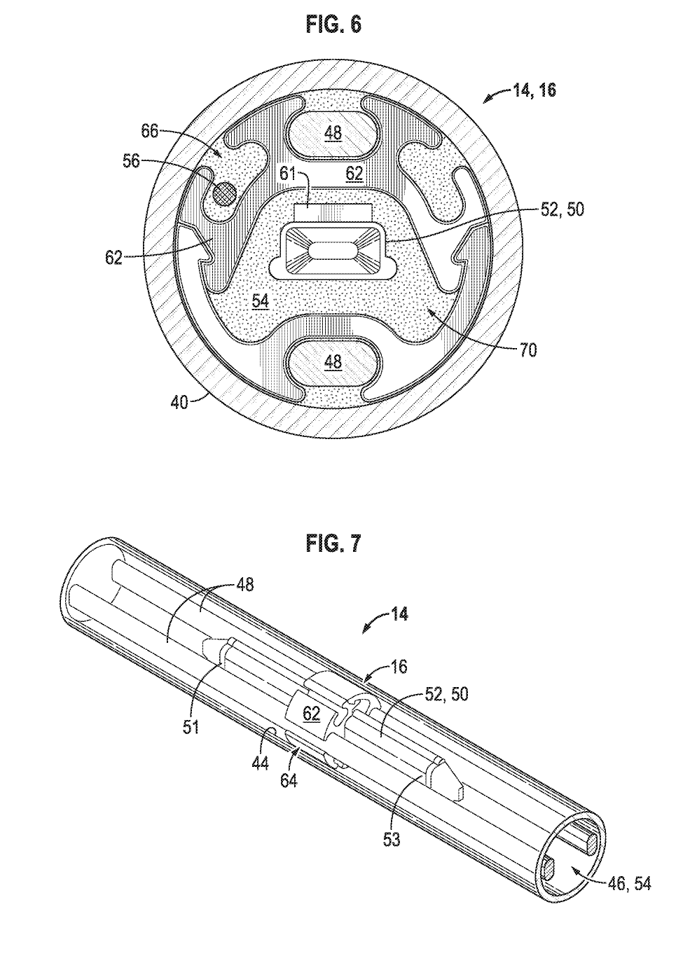

With reference to FIGS. 3-7, embodiments of sensors units 16 are illustrated including a longitudinal sensor housing 52 disposing a sensor co-located with a spacer device 62 such that the sensor housing 52 extends through the center and from opposite sides of the spacer device 62. The sensor housing 52 may be arranged such that it extends substantially equal distances from the opposite sides of the space device (i.e. symmetrical). The sensor housing 52 may be an integral portion of the spacer device 62 or may be a separate, individual element. The sensor housing 52 may be acoustically coupled, see e.g., FIGS. 4 and 5, or decoupled, see e.g., FIG. 6, from the sensor spacer device 62 and the seismic cable.

The sensor spacer device 62 has circular profile such that when positioned within the internal volume of the outer skin 40 the outer surface 64 (i.e., outer radius) is substantially similar to the inner surface 44 (i.e., inner radius) of the skin 40. In the illustrated example the outer radius 64 of the sensor spacer device 62 has portions generally designated 65 (FIG. 4), and specifically designated 65-1, 65-2 etc. that are radially separated from each other to contact the inner radius 44 (FIG. 5) to support the sensor spacer device within the skin 40. Opposing portions 65 are radially separated from one another for example between about 120 and 180 degrees. For example, with reference to FIG. 4 the outer radius portions 65-1 are separated from one another between about 120 and 180 degrees and the outer radius portions 65-2 are separated from one another between about 120 and 180 degrees. The sensor spacer device 62 includes longitudinally extending channels 66 or grooves that may be open along the outer radius 64 to the inner surface of the outer skin. The channels 66 define a longitudinally extending passage through which the strength member(s) 48 and internal components, such as wiring 56 can pass. The sensor spacer device 62 can have integrated thereto, or fit therewith the sensor housing 52 that extends from opposite sides of the sensor spacer device 62 and carries therein the seismic sensor 50, e.g., MEMS accelerometer. The sensor housing 52 may extend for example coaxial with the central longitudinal axis 68 (FIG. 3) of the sensor spacer device 62. The sensor spacer device 62 is not limited to the configurations illustrated in FIGS. 3-7.

In some embodiments, for example as illustrated in FIGS. 4-6, the sensor housing 52 is positioned through a central passage 70 extending longitudinally through the sensor spacer device 62 along the longitudinal axis. When the sensor housing and the spacer device are separate parts and the sensor housing extends through the central passage or opening in the spacer device, the sensor housing can be in a generally non-circular shape to match a non-circular shaped central passage 70 so as to prevent rotation of the sensor housing within the central passage 70. In the examples illustrated in FIGS. 4-6, the sensor spacer device 62 is formed in two sections, 62-1 and 62-2 which are connected together at corresponding latch ends 63-1 and 63-2. In some embodiments the spacer device is constructed as a single component and in some embodiment the spacer device may be constructed of more than two sections. The sensor spacer device is not limited to the illustrated configurations.

It should be appreciated that the MEMS sensors can be 1C, 2C or 3C sensors depending on the desired measurements. The MEMS sensors can have axes at right angles to one another or at other configurations. One way to orient the accelerometers is with an axis facing perpendicular to a surface of the sensor housing, with an axis facing in line with the streamer cable, and with another axis at a right angle to axis in line with the streamer and the axis facing perpendicular to the surface.

FIGS. 4 and 5 are longitudinal end views of an example of the sensing unit 16 in which the sensor housing 52 and the carried sensors are coupled to the sensor spacer device 62. In FIG. 5 the sensor housing 52 and carried sensors are anchored to a mechanical backbone, i.e., strength members 48, of the streamer cable 14 via the spacer device 62. The sensor housing 52 is in physical contact and engaged by the opposing sections or sides of the sensor support device 62 thereby rigidly connecting the sensor housing 52 and accelerometer with the sensor support device. In FIG. 5 two strength members 48 extend through the inside of the streamer 14 and through channels 66 (FIG. 4) defined by the sensor spacer device 62. The connection between the sensor spacer device 62 and the strength members 48 is a tight connection thereby anchoring the sensor spacer device to the strength members and rigidly connecting the sensor 50 in the FIG. 5 embodiment to the movement or vibrations of the strength member. This configuration also connects (couples) the movements of the streamer skin 40 to the sensor 50. Inside the streamer 14 a filler material 54 such as a gel can surround the device, thus contributing positively to the support aspects of this design, as well as the sensing performance. Though gel can be used, it should be appreciated that other materials can be used.

FIG. 6 is longitudinal end view of a streamer 14 illustrating a sensing unit 16 wherein the sensor housing 52 and sensor 50 are co-located with a spacer device 62 and decoupled from the spacer device and the seismic cable 14 for example by way of a shock absorbing material such as decoupling foam 54. Different types of filler material 54 can be utilized in different sections of the streamer cable. The sensor housing 52 extends through the central passage 70 of the spacer device 62, but is not in direct physical contact with the spacer device but is positioned within a foam 54 disposed in the central passage 70. In the illustrated example, buoyancy elements 61 are attached to the sensor housing 52 to provide neutral buoyancy to the sensor housing 52. Using buoyancy elements 61 and or selecting a filling material such that the sensor unit is neutrally buoyant couples the sensor 50 to the surrounding filler material.

In FIGS. 5 and 6, the sensor 50 is substantially centered on the longitudinal axis of the streamer 14; however, the sensor 50 may be positioned off-center. An off-center sensor 50 will be more susceptible to receiving some form of noise and by recording this noise intentionally and more clearly (e.g., noise shaping) it may more easily be filtered.

FIG. 7 illustrates a portion of a seismic cable 14 incorporating a sensor unit 16 in accordance with an embodiment of the disclosure. With additional reference to FIGS. 3-6, a sensor spacing device 62 is disposed in the internal volume 46 of the skin 40 with the outer radius 64 proximate to or in contact with the inner radius 44 of the skin. The longitudinal sensor housing 52 carrying the sensor 50 extends through the center passage 70 of the sensor support device 62. At least one and in FIG. 7 two spaced apart strength members 48 extend through the longitudinal internal volume 46 of the outer skin 40 and through channels 66 of the sensor spacing device 62. The sensor housing 52 and sensor 50 may be coupled or decoupled from the sensor support device 62 and strength members 48. The internal volume may include a filler material 54, such as a gas, liquid, gel or foam.

It should be appreciated that the different sensor unit configurations (e.g., decoupled and floating, decoupled and co-located with a spacer device, and coupled to a co-located spacer device) can be used within the same streamer cable, or even the same streamer cable section, depending on the operational needs. While the various figures show individual sensor units in the streamer, each streamer section may include two or more sensor units which may be uniformly or non- uniformly spaced along the cable.

It should be appreciated that noise is an issue in any seismic survey. Noise can be removed in the processing of the data by various techniques, but can also be controlled (e.g., shaped) by choosing particular sensor mounting designs. This can be illustrated by explaining that in practice a single streamer section can have many (sometimes hundreds of) individual sensors. A large number of sensors help provide data that can more easily be processed to remove noise. The large number of sensors required to filter the noise impacts negatively the cost of the streamer. Each extra sensor in the spread increases the cost of the system due to the cost of the sensor and its packaging, the cost of the power and communication overhead (i.e. other components required to feed the sensor with power and record its data) and the cost of processing the data from this extra sensor. If the sensors were shielded from the noise, fewer sensors could be used with acceptable results. Described herein are designs that aid in reducing the level of the noise (e.g., decoupling) and shaping the noise sensed or received so that the noise characteristics are easier to filter at later processing stages.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A seismic streamer, comprising:
an outer skin formed in a longitudinally extending tubular shape, an inner surface of the outer skin defining an internal volume;
a strength member that extends through the internal volume in a direction parallel to that of the longitudinally extending tubular shape;
a filler material disposed in the internal volume; and
a sensor housing internally disposing a seismic sensor, the sensor housing located in the internal volume.

2. The seismic streamer of claim 1, wherein the filler material comprises one or more of a gas, liquid, gel or foam.

3. The seismic streamer of claim 1, wherein the sensor housing is supported in the internal volume by the filler material.

4. The seismic streamer of claim 1, wherein the sensor housing comprises a buoyancy element attached thereto, whereby the sensor housing is substantially neutrally buoyant in the filler material.

5. The seismic streamer of claim 1, wherein the sensor housing is disposed between a pair of spacer devices that support the outer skin.

6. The seismic streamer of claim 1, wherein the sensor housing is disposed between a pair of spacer devices that support the outer skin; and
the filler material between the pair of spacer devices comprises a foam.

7. The seismic streamer of claim 1, further comprising a sensor spacer device located within the internal volume having an outer radius that is substantially similar to the inner radius of the inner surface of the outer skin, wherein the sensor housing is co-located with the sensor spacer device.

8. The seismic streamer of claim 7, wherein the sensor housing extends from opposite sides of the sensor spacer device.

9. The seismic streamer of claim 7, wherein the seismic sensor is one of coupled or decoupled from the strength member.

10. The seismic streamer of claim 9, wherein the sensor spacer device is connected to the strength member.

11. The seismic streamer of claim 7, wherein the sensor housing is disposed in a passage of the sensor spacer device and the sensor housing physically engages the sensor housing.

12. The seismic streamer of claim 7, wherein the sensor spacer device is disposed in a passage through the sensor spacer device and the sensor housing is physically separated from the sensor spacer device.

13. The seismic streamer of claim 12, wherein the sensor housing comprises a buoyancy element attached thereto.

14. A method, comprising disposing in an internal volume of an outer skin of a seismic streamer a longitudinally extending sensor housing that internally carries a seismic sensor.

15. The method of claim 14, comprising supporting the sensor housing in a filler material.

16. The method of claim 15, wherein the sensor housing is located between a pair of spaced apart spacer devices that support the outer skin.

17. The method of claim 14, wherein the sensor housing is co-located with a sensor spacer device having an outer radius that is substantially similar to the inner radius of the inner surface of the outer skin.

18. The method of claim 14, wherein the sensor housing is disposed in a passage of the sensor spacer device and the sensor housing physically engages the sensor housing.

19. The method of claim 14, wherein the sensor spacer device is disposed in a passage through the sensor spacer device and the sensor housing is physically separated from the sensor spacer device.

20. A seismic sensor unit for use in a seismic streamer, comprising:
an elongated enclosed housing;
an accelerometer disposed inside of the elongated housing; and
sensor electronic connected to the accelerometer and disposed inside of the elongated housing.
